(19) United States
(12) Patent Application Publication
(10) Pub. No.: US 2014/0086338 A1
(43) Pub. Date: Mar. 27, 2014

(54) SYSTEMS AND METHODS FOR INTEGRATED METADATA INSERTION IN A VIDEO ENCODING SYSTEM

(71) Applicants: Ning Lu, Saratoga, CA (US); Atthar H. Mohammed, Folsom, CA (US); Satya N. Yedidi, Roseville, CA (US); Ping Liu, Sunnyvale, CA (US)

(72) Inventors: Ning Lu, Saratoga, CA (US); Atthar H. Mohammed, Folsom, CA (US); Satya N. Yedidi, Roseville, CA (US); Ping Liu, Sunnyvale, CA (US)

(21) Appl. No.: 13/996,015

(22) PCT Filed: Dec. 28, 2011
(86) PCT No.: PCT/US11/67637

§ 371 Date: Dec. 6, 2013

(51) Int. Cl. H04N 7/26

(52) U.S. Cl. CPC H04N 19/00551
USPC 375/240.26

(57) ABSTRACT

Systems and methods for the insertion of metadata in a video encoding system, without software intervention. Header data may be provided to hardware circuitry, which may then construct and format one or more headers to accommodate the header data. The header data may then be appended to the encoded video. The combination of the header data and the encoded video may then be multiplexed with audio data and/or user data, and encrypted if necessary.

### BACKGROUND

In a number of video standards, data related to the video may need to be added to an encoded video stream. This data may be metadata for the video, and may have nothing to do with the encoding process. This metadata may include a time stamp, a color conversion formula, and/or a frame rate, for example.

Typically, such metadata may be built into one or more headers that are appended the encoded video. Currently, however, headers are defined according to encoder settings. Any subsequent modification of these headers generally requires software intervention, to manipulate or change the headers that have already been created in hardware. In some systems, the headers created in hardware must be constructed in a manner that facilitates subsequent manipulation by software. This requires complexity in the headers, given that they must allow flexibility for a variety of metadata types that may need to be accommodated.

This process of constructing headers can be inefficient. Here, headers may be created in hardware, and then may be manipulated by software. Moreover, software processing may be time intensive, and is generally slower than hardware processing. Further, a number of transitions must be made between hardware processing and software processing. Encoding must take place in hardware, after which software must perform header manipulations to accommodate the metadata. After this phase, hardware processing may resume to multiplex audio data with the encoded video, for example. Encryption may also be required, which is may be a hardware or software process. Such transitions between hardware and software processing may complicate and ultimately slow the overall process.

### BRIEF DESCRIPTION OF THE DRAWINGS/FIGURES

FIG. 1 is a block diagram illustrating metadata insertion in a video encoding system.

FIG. 2 is a block diagram illustrating metadata insertion in a video encoding system, according to an embodiment.

FIG. 3 is a flowchart illustrating the processing of the system described herein, according to an embodiment.

FIG. 4 is a block diagram further illustrating metadata insertion in a video encoding system, according to an embodiment.

FIG. 5 illustrates a system that may receive or generate encoded video with appended headers as described herein, according to an embodiment.

FIG. 6 illustrates a mobile device that may receive or generate encoded video with appended headers as described herein, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

The systems and methods described herein provide for the insertion of metadata in a video encoding system, without software intervention. Header data may be provided to hardware circuitry, which may then construct and format one or more headers to accommodate the header data. The header data may then be appended to encoded video. The combination of the header data and the encoded video may then be multiplexed with audio data and/or user data, and encrypted if necessary. This does not require a software process to modify pre-constructed headers that may result from the encoding process. Rather, header information may be provided to the hardware, which may then create and append headers as necessary.

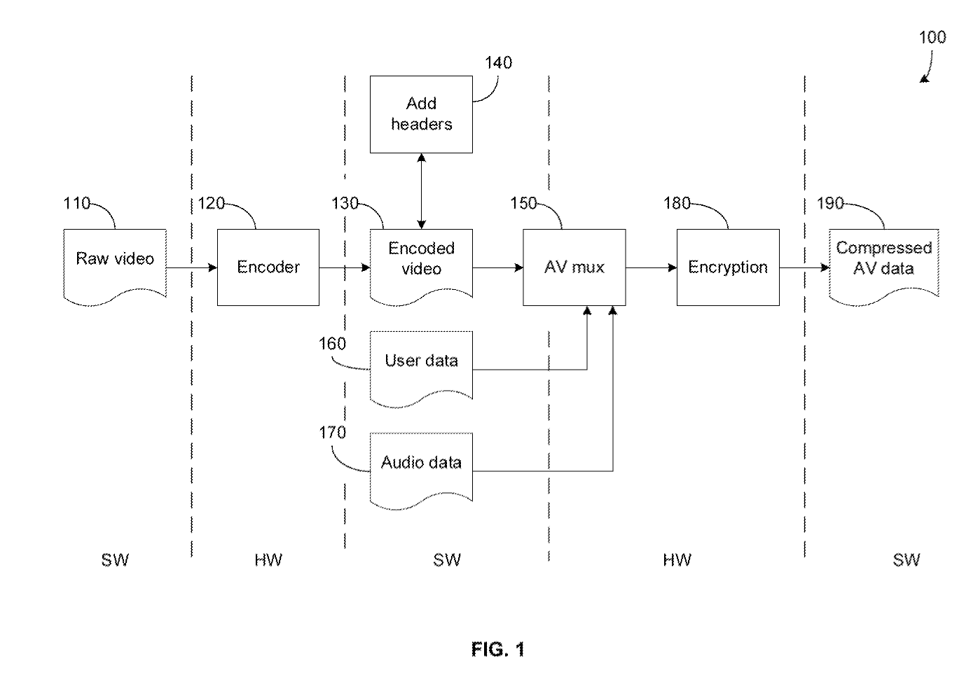

An example of conventional processing for the insertion of metadata is illustrated in FIG. 1. Raw video data 110 may be processed by software, and then provided to a hardware video encoder 120. The output of video encoder 120 is shown as encoded video 130. Normally, fixed headers may be created in the encoding process, as defined by the settings applied to video encoder 120. In software, these headers may be manipulated by a software module 140. This module may modify the headers to accommodate metadata as necessary. Such metadata may include, for example, timestamps, specification of color conversion formulas, or frame rates.

The encoded video 130, along with any modified headers, may then be sent to an audiovisual (AV) multiplexer 150, to be multiplexed with user data 160 and/or audio data 170. Note that in this phase, processing may be once again performed in hardware rather than software. The output of multiplexer 150 may then be sent to an encryption module 180. The encrypted result is shown as compressed AV data 190. Further processing of compressed AV data 190 may then be performed in software.

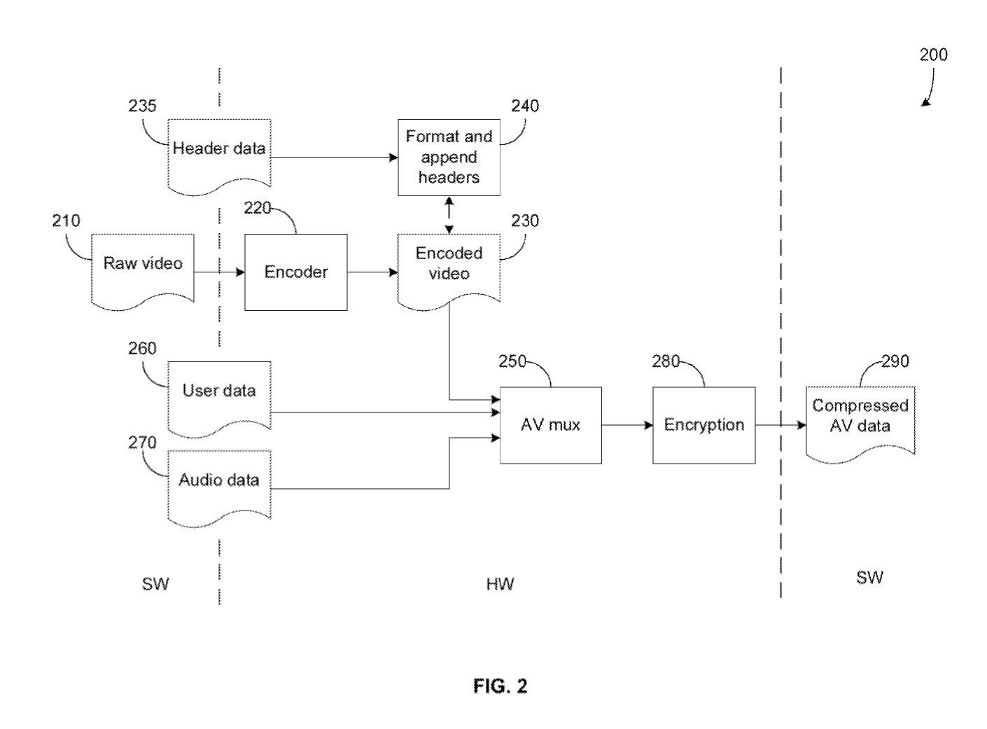

Processing for the insertion of metadata is illustrated in FIG. 2, according to an embodiment. Here, raw video data 210 may be passed to a hardware encoder 220. This may result in the encoded video 230. Header data 235 may be provided to a hardware module 240, which may be responsible for constructing and formatting one or more headers to accommodate the header data 235, and appending the header(s) to the encoded video 230. The encoded video 230, along with any appended headers created by module 240, may be passed to a hardware AV multiplexer 250. Here, this information may be multiplexed with user data 260 and/or audio data 270. The resulting multiplexed information may be passed to a hardware encryption module 280, if encryption is required. In an alternative embodiment, the encryption module 280 may be implemented in software. The output of encryption module 280 is shown as compressed AV data 290. Data 290 may then be processed further in software as required.

In the embodiment of FIG. 2, software modification of headers created in hardware may not be necessary. Rather, header data is formatted and appended to encoded video in hardware. This may improve the speed and efficiency of the processing illustrated in FIG. 1. Note that the embodiment of FIG. 2 may also require fewer transitions between software and hardware processing. As shown by the vertical lines, the processing of FIG. 1 includes four such transitions; the processing of the embodiment of FIG. 2 may require only two such transitions.

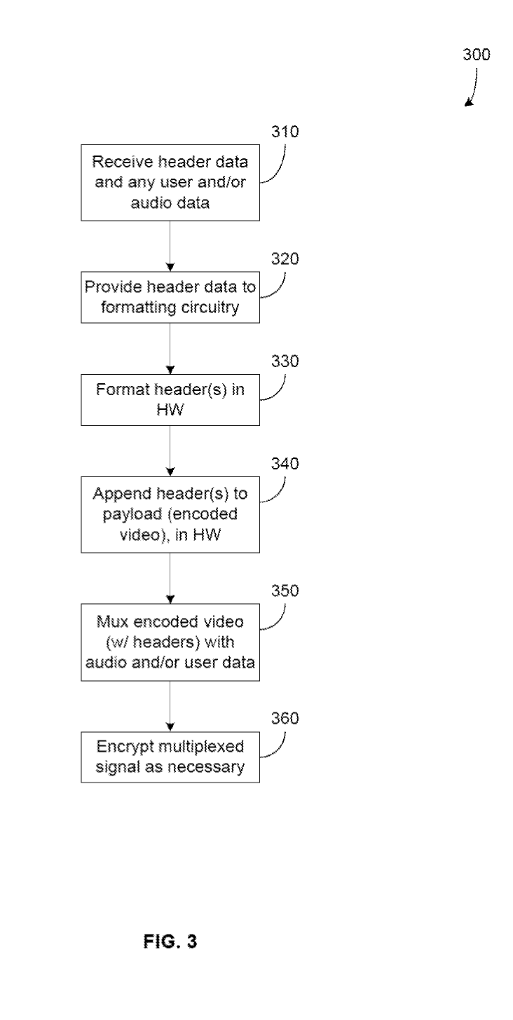

FIG. 3 illustrates processing of the system described herein, according to an embodiment. At 310, header data is received, where the header data represents metadata that may be incorporated into headers. In addition, audio data and user data may also be received, where these forms of data may ultimately be multiplexed with the encoded video data. At 320, the header data may be provided to formatting circuitry, which may construct headers incorporating the header data. In an embodiment, the formatting may be performed at 330, and may be based on the types and amounts of header data. At 340, the resulting headers may be appended to a payload that includes the encoded video, using hardware appending circuitry. At 350, the encoded video, along with the appended headers, may be multiplexed with any audio data and or user data. At 360, encryption may be performed on the multiplexed data if necessary.

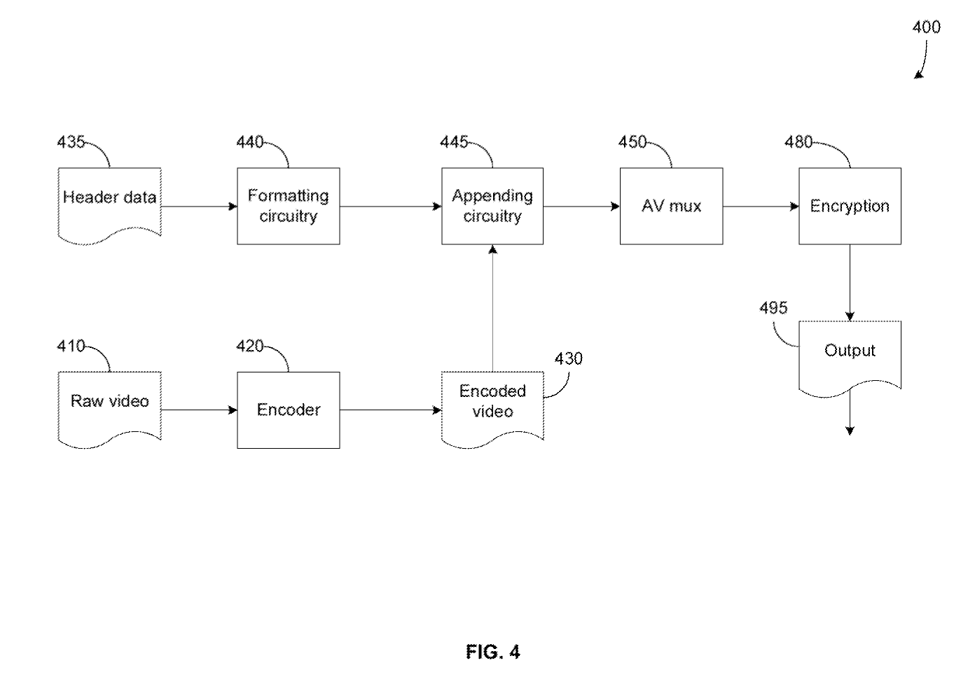

The formatting and appending circuitry may operate as illustrated in FIG. 4. As discussed above, raw video (shown here as 410) may be input to a hardware encoder 420. The resulting encoded video 430 may be passed to appending circuitry 445. Header data 435 may be sent to hardware formatting circuitry 440, and the resulting headers may be sent to appending circuitry 445. The output of appending circuitry 445 may include a payload that includes encoded video 430, along with the appended headers. This data is sent to AV multiplexer 450, where it may be multiplexed with any user data and/or audio data (not shown). If necessary, encryption may be applied by encryption module 480. The encryption module 480 may be implemented in hardware; alternatively the encryption module 480 may be implemented using software logic that executes on a programmable processor. The final output is shown as output 495.

In an embodiment, the formatting circuitry 440 and the appending circuitry 445 may be separate modules; alternatively, these modules may be incorporated into a single module as represented by module 240 of FIG. 2.

One or more features disclosed herein may be implemented in discrete and integrated circuit application specific integrated circuit (ASIC) logic, and microcontrollers, and may be implemented as part of a domain-specific integrated circuit package, or a combination of integrated circuit packages.

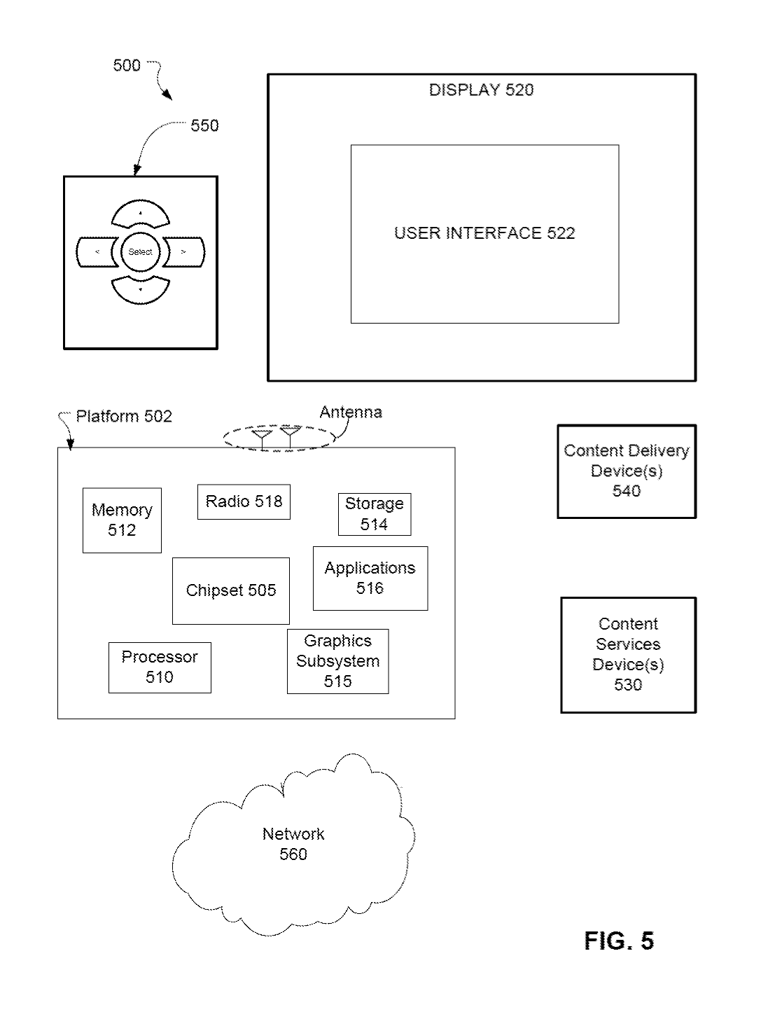

FIG. 5 illustrates an embodiment of a larger system 500. The video encoding systems 200 and 400 may be employed to generate encoded video that may be received and used by a system such as system 500. Additionally or alternatively, encoded video may be generated according to the embodiments 200 and 400, within system 500, for purposes of sending the encoded video elsewhere. In embodiments, system 500 may be a media system although system 500 is not limited to this context. For example, system 500 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 500 comprises a platform 502 coupled to a display 520. Platform 502 may receive content from a content device such as content services device(s) 530 or content delivery device(s) 540 or other similar content sources. A navigation controller 550 comprising one or more navigation features may be used to interact with, for example, platform 502 and/or display 520. Each of these components is described in more detail below.

In embodiments, platform 502 may comprise any combination of a chipset 505, processor 510, memory 512, storage 514, graphics subsystem 515, applications 516 and/or radio 518. In an embodiment, systems 200 or 400 may also be incorporated in platform 502. Chipset 505 may provide intercommunication among processor 510, memory 512, storage 514, graphics subsystem 515, applications 516 and/or radio 518. For example, chipset 505 may include a storage adapter (not depicted) capable of providing intercommunication with storage 514.

Processor 510 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 510 may comprise dual-core processor(s), dual-core mobile processor(s), and so forth.

Memory 512 may be implemented as a volatile memory device such as, but not limited to, a Random Access Memory (RAM), Dynamic Random Access Memory (DRAM), or Static RAM (SRAM).

Storage 514 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 514 may comprise technology to increase the storage performance enhanced protection for valuable digital media when multiple hard drives are included, for example.

Graphics subsystem 515 may perform processing of images such as still or video for display. Graphics subsystem 515 may be a graphics processing unit (GPU) or a visual processing unit (VPU), for example. An analog or digital interface may be used to communicatively couple graphics subsystem 515 and display 520. For example, the interface may be any of a High-Definition Multimedia Interface, DisplayPort, wireless HDMI, and/or wireless HD compliant techniques. Graphics subsystem 515 could be integrated into processor 510 or chipset 505. Graphics subsystem 515 could be a stand-alone card communicatively coupled to chipset 505.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 518 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 518 may operate in accordance with one or more applicable standards in any version.

In embodiments, display 520 may comprise any television type monitor or display. Display 520 may comprise, for example, a computer display screen, touch screen display, video monitor, television-like device, and/or a television. Display 520 may be digital and/or analog. In embodiments, display 520 may be a holographic display. Also, display 520 may be a transparent surface that may receive a visual projection. Such projections may convey various forms of information, images, and/or objects. For example, such projections may be a visual overlay for a mobile augmented reality (MAR) application. Under the control of one or more software applications 516, platform 502 may display user interface 522 on display 520.

In embodiments, content services device(s) 530 may be hosted by any national, international and/or independent service and thus accessible to platform 502 via the Internet, for example. Content services device(s) 530 may be coupled to platform 502 and/or to display 520. Platform 502 and/or content services device(s) 530 may be coupled to a network 560 to communicate (e.g., send and/or receive) media information to and from network 560. Content delivery device(s) 540 also may be coupled to platform 502 and/or to display 520.

In embodiments, content services device(s) 530 may comprise a cable television box, personal computer, network, telephone, Internet enabled devices or appliance capable of delivering digital information and/or content, and any other similar device capable of unidirectionally or bidirectionally communicating content between content providers and platform 502 and/display 520, via network 560 or directly. It will be appreciated that the content may be communicated unidirectionally and/or bidirectionally to and from any one of the components in system 500 and a content provider via network 560. Examples of content may include any media information including, for example, video, music, medical and gaming information, and so forth.

Content services device(s) 530 receives content such as cable television programming including media information, digital information, and/or other content. Examples of content providers may include any cable or satellite television or radio or Internet content providers. The provided examples are not meant to limit embodiments of the invention.

In embodiments, platform 502 may receive control signals from navigation controller 550 having one or more navigation features. The navigation features of controller 550 may be used to interact with user interface 522, for example. In embodiments, navigation controller 550 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 550 may be echoed on a display (e.g., display 520) by movements of a pointer, cursor, focus ring, or other visual indicators displayed on the display. For example, under the control of software applications 516, the navigation features located on navigation controller 550 may be mapped to virtual navigation features displayed on user interface 522, for example. In embodiments, controller 550 may not be a separate component but integrated into platform 502 and/or display 520. Embodiments, however, are not limited to the elements or in the context shown or described herein.

In embodiments, drivers (not shown) may comprise technology to enable users to instantly turn on and off platform 502 like a television with the touch of a button after initial boot-up, when enabled, for example. Program logic may allow platform 502 to stream content to media adaptors or other content services device(s) 530 or content delivery device(s) 540 when the platform is turned “off.” In addition, chip set 505 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 500 may be integrated. For example, platform 502 and content services device(s) 530 may be integrated, or platform 502 and content delivery device(s) 540 may be integrated, or platform 502, content services device(s) 530, and content delivery device(s) 540 may be integrated, for example. In various embodiments, platform 502 and display 520 may be an integrated unit. Display 520 and content service device(s) 530 may be integrated, or display 520 and content delivery device(s) 540 may be integrated, for example. These examples are not meant to limit the invention.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 502 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

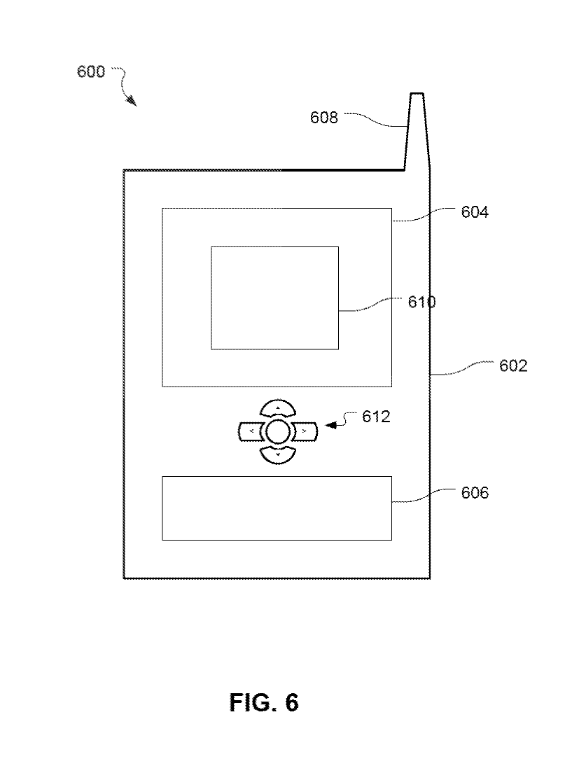

As described above, system 500 may be embodied in varying physical styles or form factors. FIG. 6 illustrates embodiments of a small form factor device 600 in which system 500 may be embodied. In embodiments, for example, device 600 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 6, device 600 may comprise a housing 602, a display 604, an input/output (I/O) device 606, and an antenna 608. Device 600 also may comprise navigation features 612. Display 604 may comprise any suitable display unit for displaying information appropriate for a mobile computing device. I/O device 606 may comprise any suitable I/O device for entering information into a mobile computing device. Examples for I/O device 606 may include an alphanumeric keyboard, a numeric keypad, a touch pad, input keys, buttons, switches, rocker switches, microphones, speakers, voice recognition device and software, and so forth. Information also may be entered into device 600 by way of microphone. Such information may be digitized by a voice recognition device. The embodiments are not limited in this context.

Various embodiments of system 500 may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment of system 500 may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
receiving header data;
formatting the header data into one or more headers using hardware formatting circuitry;
appending the one or more headers to a payload comprising encoded video, using hardware appending circuitry; and
outputting the resulting encoded video and one or more appended headers,
wherein said formatting and appending are performed without software intervention.

2. The method of claim 1, further comprising:
multiplexing audio data with the encoded video and the one or more appended headers, performed before said outputting.

3. The method of claim 1, further comprising:
multiplexing user data with the encoded video and the one or more appended headers, performed before said outputting.

4. The method of claim 1, further comprising:
encrypting the encoded video and the one or more appended headers, performed before said outputting.

5. The method of claim 1, wherein the encoded video is compressed.

6. The method of claim 1, wherein said formatting of the header data depends on the amount of header data and on one or more types of the header data.

7. The method of claim 1, wherein the header data comprises one or more of
a frame rate;
a timestamp; and
a color conversion formula.

8. A system, comprising:
a video encoder, configured to receive raw video and encode and compress the raw video to produce encoded video;
formatting circuitry, configured to receive header data and to format the header data into one or more headers; and
appending circuitry, configured to append the one or more headers to a payload comprising the encoded video,
wherein said formatting circuitry and said appending circuitry operate without software intervention.

9. The system of claim 8, further comprising:
a multiplexer, configured to multiplex audio data with the encoded video and the one or more appended headers.

10. The system of claim 8, further comprising:
a multiplexer configured to multiplex user data with the encoded video and the one or more appended headers.

11. The system of claim 8, wherein operation of said formatting circuitry depends on the amount and types of the header data.

12. The system of claim 8, wherein the header data comprises one or more of
a frame rate;
a timestamp; and
a color conversion formula.

13. A system, comprising:
a video encoder, configured to receive raw video and encode and compress the raw video to produce encoded video;
formatting circuitry, configured to receive header data and format the header data into one or more headers;
appending circuitry, configured to append the one or more headers to a payload comprising the encoded video; and
an encryption module, configured to encrypt the encoded video and the appended headers,
wherein said formatting circuitry and sent appending circuitry operate without software intervention.

14. The system of claim 13, further comprising:
a multiplexer, configured to multiplex audio data with the encoded video and the one or more appended headers.

15. The system of claim 13, further comprising:
a multiplexer, configured to multiplex user data with the encoded video and the one or more appended headers.

16. The system of claim 13, wherein operation of said formatting circuitry depends on the amount and type(s) of the header data.

17. The system of claim 13, wherein the header data comprises one or more of
a frame rate;
a timestamp; and
a color conversion formula.

18. The system of claim 13, wherein the system is incorporated into a computing system.

19. The system of claim 18, wherein said computing system comprises a portable computing system.

20. The system of claim 18, wherein said computing system comprises a smart phone.
